(19) United States
(12) Patent Application Publication
(10) Pub. No.: US 2025/0269542 A1
(43) Pub. Date: Aug. 28, 2025

(54) ROBOTIC END EFFECTOR INCLUDING A NODE

(71) Applicant: Ford Global Technologies, LLC, Dearborn, MI (US)

(72) Inventors: Jason Powell, Ypsilanti, MI (US); Ali Zead Rammouni, Dearborn, MI (US); Aaron J. Dorsey, Milford, MI (US)

(73) Assignee: Ford Global Technologies, LLC, Dearborn, MI (US)

(21) Appl. No.: 18/587,292

(22) Filed: Feb. 26, 2024

(51) Int. Cl. B25J 15/00; B25J 19/00

(52) U.S. Cl. CPC B25J 15/0019; B25J 19/007

(57) ABSTRACT

A robotic end effector includes a node having at least one wall. Each wall has a corresponding interior side and a corresponding exterior side. The interior side of the wall defines a closed profile disposed about an axis such that the interior side of the wall defines a cavity and the wall defines an end aperture open to the cavity through an axial end of the node. The end aperture being configured to receive a frame member. The wall includes a port having an outlet open through the interior side of the wall and an inlet open through the exterior side of the wall. The interior side of the wall defines a plurality of recessed channels that intersect the outlet of the port.

### FIELD

The present disclosure relates to a robotic end effector including a node.

### BACKGROUND

The statements in this section merely provide background information related to the present disclosure and may not constitute prior art.

Industrial robots have been used for a variety of manufacturing operations, including by way of example, welding, placement of parts for subsequent fabrication or assembly operations, and moving parts from one location to another such as retrieving parts from a storage location and moving them to an assembly station. These industrial robots include end effectors, which are essentially the hands of the robot. These end effectors come in a variety of configurations depending on the particular manufacturing operation. However, end effectors often are large and heavy, and lack mechanical repeatability.

These issues related to robotic end effectors, among other issues related to robotic end effectors, are addressed by the present disclosure.

### SUMMARY

This section provides a general summary of the disclosure and is not a comprehensive disclosure of its full scope or all of its features.

In one form, the present disclosure provides a robotic end effector that includes a first node. The first node includes at least one wall. The wall has a corresponding interior side and a corresponding exterior side. The interior side of the wall defines a closed profile disposed about an axis such that the interior side of the wall defines a cavity and the wall defines a first end aperture open to the cavity through an axial end of the first node. The first end aperture is configured to receive a first frame member. The wall includes a first port having a first outlet open through the interior side of the first wall and a first inlet open through the exterior side of the first wall. The interior side of the first wall defines a plurality of first recessed channels that intersect the first outlet of the first port.

In variations of the robotic end effector of the above paragraph, which can be implemented individually or in any combination: the first node is made of plastic; the interior side of the first node defines an interior surface, the first recessed channels are formed in the interior surface; the first node includes a locating feature that is adjacent the first port and configured to facilitate positioning of the first node relative to the frame, the locating feature includes a second outlet open through the interior side of the first node and a second inlet end open through to the exterior side of the first node; the first recessed channels are spaced apart from the second outlet of the locating feature and extend around the second outlet of the locating feature; a second port that includes a second outlet open through the interior side of the first node and a second inlet open through the exterior side of the first node; second recessed channels formed in the interior side of the first node and intersecting the second outlet of the second port; the second recessed channels have a pattern that is different from a pattern of the first recessed channels; the first node includes a mounting feature that is adjacent to the first port and configured to mount a structure to the first node; the mounting feature includes a plurality of threaded apertures; the robotic end effector further includes the frame, w a bonding agent flows through the first port to the first recessed channels to attach the first node to the frame; and a second node that is spaced apart from the first node and attached to the frame.

In another form, the present disclosure provides a robotic end effector that includes a frame and a first node. The frame includes a first member and a second member that extends in a direction that is different than the first member. The first node includes a first interior side, a second interior side, and an exterior side. The first interior side faces the first member and defines a first interior cavity that receives the first member. The second interior side faces the second member and defines a second interior cavity that receives the second member. The exterior side faces away from the frame. The first node further includes a first port, first recessed channels, a second port and second recessed channels. The first port includes a first outlet that opens through to the first interior side of the first node and a first inlet that opens through to the exterior side of the first node. The first recessed channels formed in the first interior side of the first node are proximate the first member and intersects the first outlet of the first port. The second port includes a second outlet that opens through to the second interior side of the first node and a second inlet that opens through to the exterior side of the first node. The second recessed channels are formed in the second interior side of the first node proximate the second member and intersecting the second outlet of the second port.

In variations of the robotic end effector of the above paragraph, which can be implemented individually or in any combination: the second recessed channels form a pattern that is different from a pattern of the first recessed channels; the robotic end effector includes a second node that is spaced apart from the first node and attached to the frame; the first node includes a mounting feature that is adjacent to the first port and configured to mount a structure to the first node; the first node further includes a third port and an internal port; the third port includes a third outlet and a third inlet, the third inlet opens through to the exterior side of the first node; the internal port is located within the first node and extends from the first interior side of the first node to the second interior side of the first node, the internal port in fluid communication with the third outlet of the third port; the internal port includes a diameter that is greater than a diameter of the third port; the first node includes a locating feature that is adjacent to one of the first and second ports and that facilitates positioning of the first node relative to the frame, the locating feature includes a third outlet that opens through to one of the first and second interior sides of the first node and a third inlet that opens through to the exterior side of the first node; and one of the first and second recessed channels are spaced apart from the third outlet of the locating feature and extend around the third outlet of the locating feature.

In yet another form, the present disclosure provides a method of assembling a robotic end effector. The method includes inserting a first frame member into a first interior cavity of a node such that first recessed channels defined by a first interior surface of the first interior cavity are proximate the first frame member; inserting a second frame member into a second interior cavity of the node such that second recessed channels defined by a second interior surface of the second interior cavity are proximate the second frame member; injecting a first bonding agent into a first port of the node such that it flows along the first recessed channels in the first interior surface; and injecting a second bonding agent into a second port of the node such that it flows along the second recessed channels in the second interior surface.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a robot including a robotic end effector secured to a workpiece in accordance with the principles of the present disclosure;

FIG. 2 is a perspective view of the robotic end effector of FIG. 1 secured to the workpiece;

FIG. 3 is a top view of the robotic end effector of FIG. 1;

FIG. 4 is a perspective view of the robotic end effector of FIG. 1;

FIGS. 5A-5H are perspective views of various nodes of the robotic end effector of FIG. 1;

FIG. 6 is a cross-sectional view of the robotic end effector of FIG. 1 taken along line 6-6 of FIG. 4;

FIG. 7 is a cross-sectional view of the robotic end effector of FIG. 1 taken along line 7-7 of FIG. 4;

FIG. 8 is a cross-sectional view of one robotic end effector of FIG. 1;

FIG. 9 is a perspective view of one robotic end effector of FIG. 1;

FIG. 10 is a cross-sectional view of one robotic end effector of FIG. 1; and

FIG. 11 is a flowchart depicting a method for assembly the robotic end effector of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

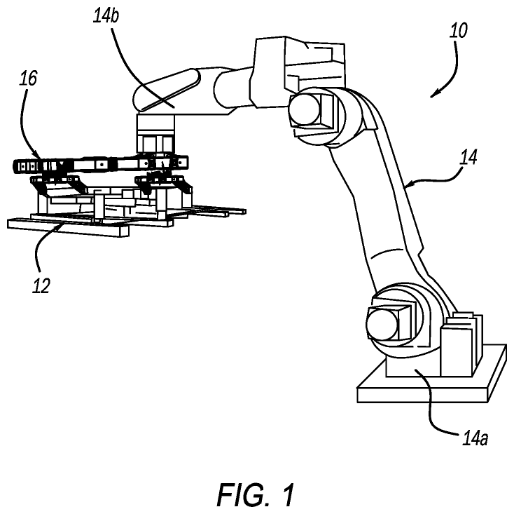

With reference to FIG. 1, a robot 10 for securing and moving a workpiece or part 12 is provided. In the example illustrated, the workpiece 12 is a stamped plate. However, the workpiece 12 may be other suitable objects such as a component built using another manufacturing process (e.g., forming, joining, extrusion, casting), or an additive manufacturing process (i.e., a 3-D printing). In the example illustrated, the robot 10 is positioned on and secured to a fixed surface (e.g., a ground surface of a manufacturing facility) near a workstation (not shown). However, in some configurations, the robot 10 may be positioned on a movable platform (i.e., the platform moves to the workstation where the robot 10 grasps and moves the workpiece 12 from a rack, for example, to the workstation). In such configuration, the platform may be moved automatically or manually.

The robot 10 includes a robot arm 14 and a robotic end effector 16. The robot arm 14 includes a plurality of segments connected to each other at joints, thereby allowing the robot arm 14 to have multiple degrees of freedom. The robot arm 14 is also secured to the fixed surface at a first end 14a. In some variations, the robot arm 14 includes an optional adapter (not shown) that is adapted to be secured to the fixed surface.

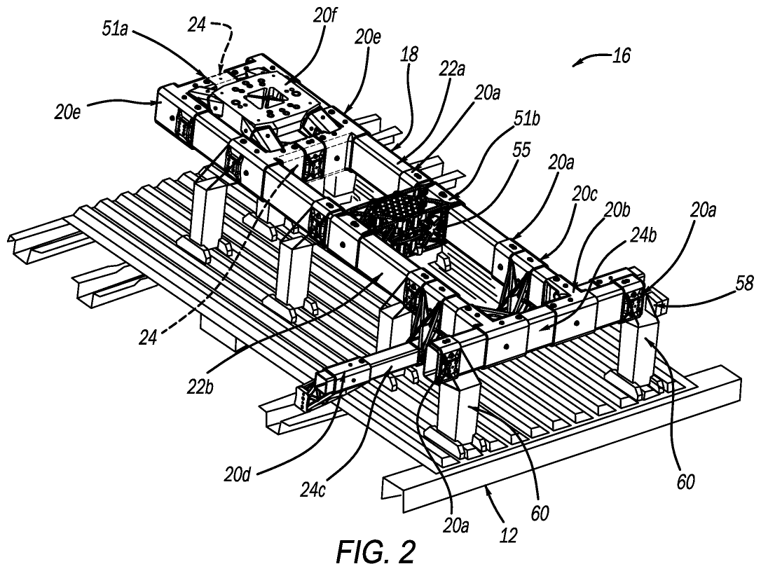

With reference to FIGS. 2-4, the robotic end effector 16 is used to secure or otherwise attach the workpiece 12 (FIG. 2) to the robot arm 14 and includes a frame 18 and a plurality of nodes 20a, 20b, 20c, 20d, 20e, 20f. In one form, the frame 18 may be manufactured using traditional manufacturing processes such as casting, joining or forming, for example. In another form, the frame 18 may be manufactured using an additive manufacturing process (i.e., 3-D printing). The frame 18 may be made of a carbon fiber material, for example, and may include a pair of rails or frame members 22a, 22b and a plurality of cross members 24a, 24b, 24c. The pair of frame members 22a, 22b are spaced apart from each other and extend along a longitudinal direction X of the robotic end effector 16. In the example illustrated, each frame member 22a, 22b has a rectangular shape and includes a plurality of sides that cooperate with each to define a cavity (not specifically shown). In some forms, the frame members 22a, 22b may have a circular shape, a square shape, or any other suitable shape.

Each cross member 24a, 24b, 24c has a rectangular or square shape and includes a plurality of sides that cooperate with each to define a cavity. In some forms, the cross members 24a, 24b, 24c may have a circular shape, a pentagonal shape, or any other suitable shape. Each cross member 24a extends in a transverse direction Y of the robotic end effector 16 between the pair of frame members 22a, 22b and is connected to the pair of frame members 22a, 22b by the nodes 20e, which will be described in more detail below.

Each cross member 24b extends in the transverse direction Y past the pair of frame members 22a, 22b and is connected to the pair of frame members 22a, 22b by the nodes 20b, which will be described in more detail below. Each cross member 24c extends in a transverse direction Y past the pair of frame members 22a, 22b and is connected to the pair of frame members 22a, 22b by the nodes 20c, which will be described in more detail below. In the example illustrated, the cross member 24c is located below the pair of frame members 22a, 22b and below the cross members 24a, 24b.

The nodes 20a, 20b, 20c, 20d, 20e, 20f connect parts of the frame 18 to each other and/or connects the frame 18 to a separate structure (e.g., a securing or attachment structure). For example, each node 20e connects a respective frame member 22a, 22b to a respective cross member 24a and/or connects the frame 18 to the robot arm 14 via node 20f. In another example, each node 20a connects the frame 18 to an attachment structure 60 that attaches or otherwise secures the workpiece 12. In yet another example, each node 20c connects a respective frame member 22a, 22b to the cross member 24c. Each node 20a, 20b, 20c, 20d, 20e, 20f is in the form of a single unitized, monolithic body that can be manufactured by an additive manufacturing process and secured to the frame 18. The manufacturing process can include laser sintering, for example, that can generally include a laser (not shown), a device (not shown) for applying subsequent layers of powdered sintering material (e.g., polyamide powder), and a controller (not shown) that controls operation of the laser and the amount and timing of the deposition of the polyamide powder. It should be understood that other 3D printing or additive manufacturing methods may be employed to achieve the unitized, monolithic body, along with a variety of different materials, while remaining within the scope of the present disclosure. In some forms, the nodes 20a, 20b, 20c, 20d, 20e, 20f may be manufactured directly onto the frame 18 using at least one additive manufacturing technique or process, such as, for example, directed energy deposition (DED), wire fed arc weld, powder-laser directed energy deposition, or cold spray.

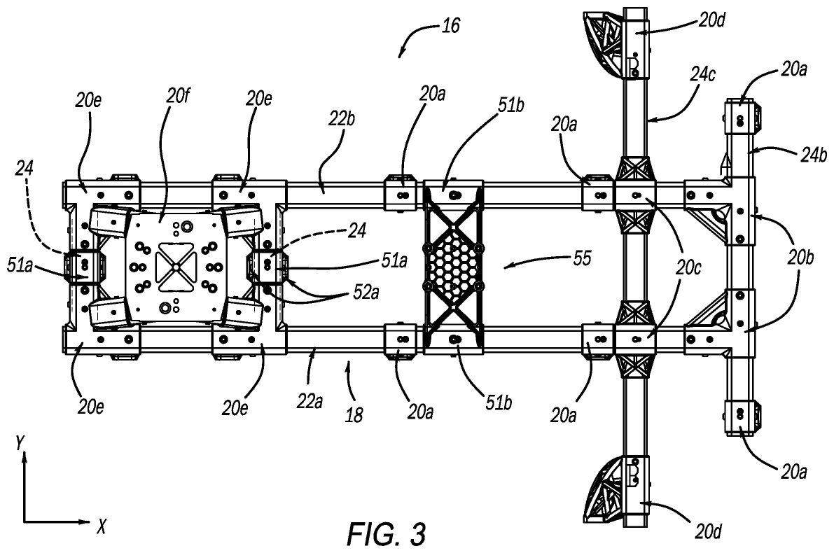

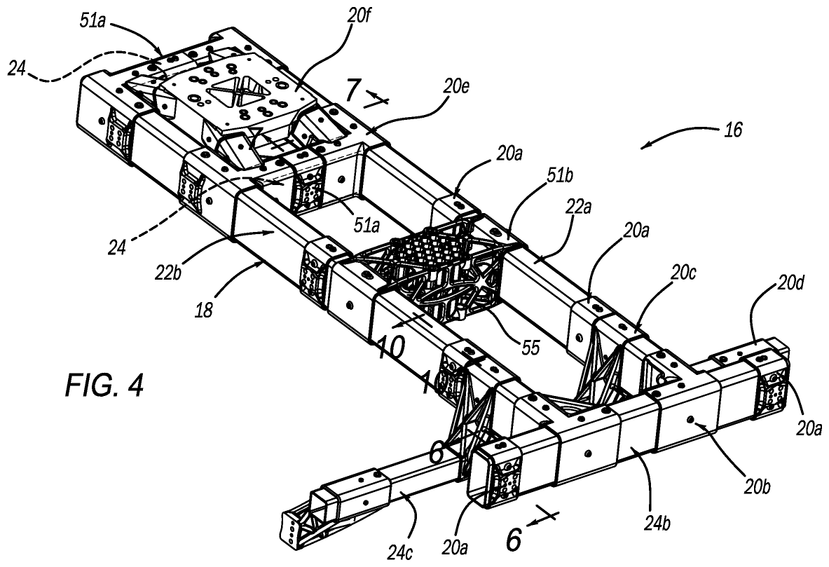

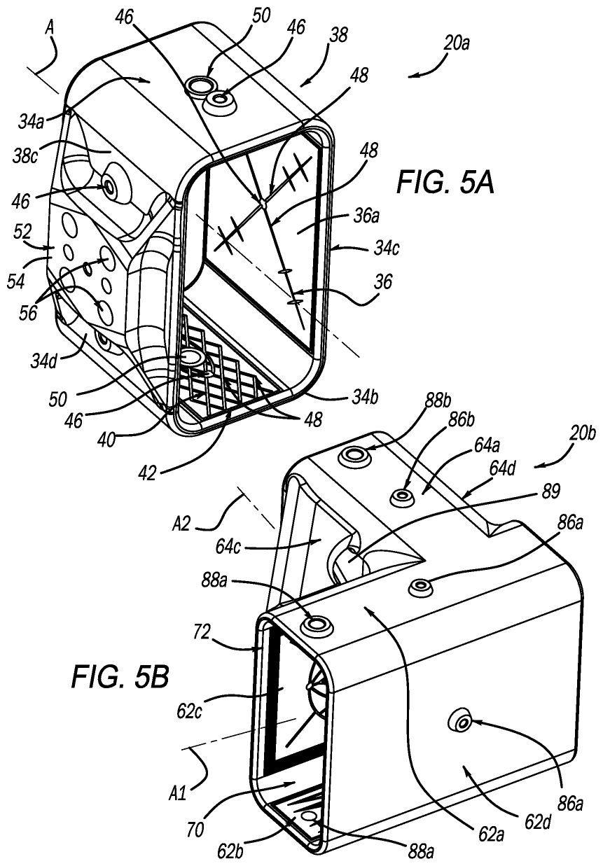

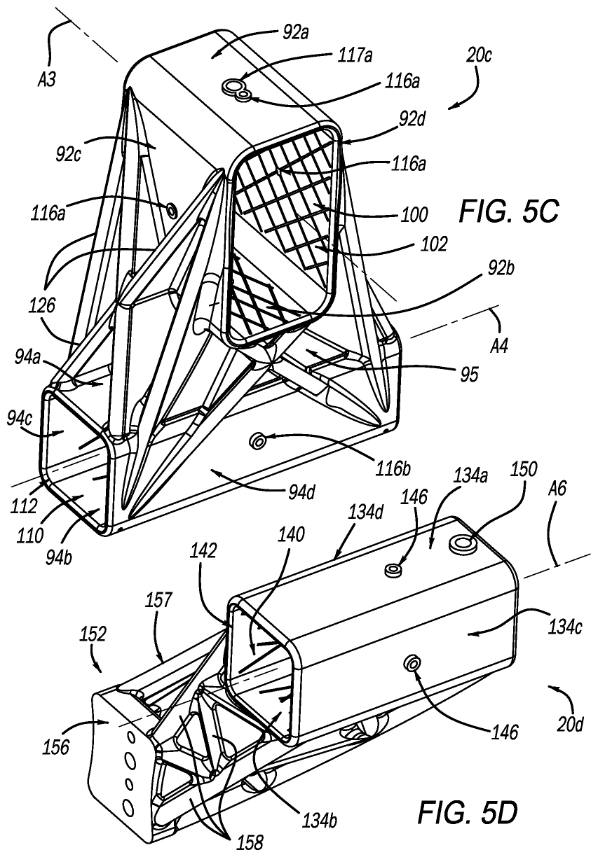

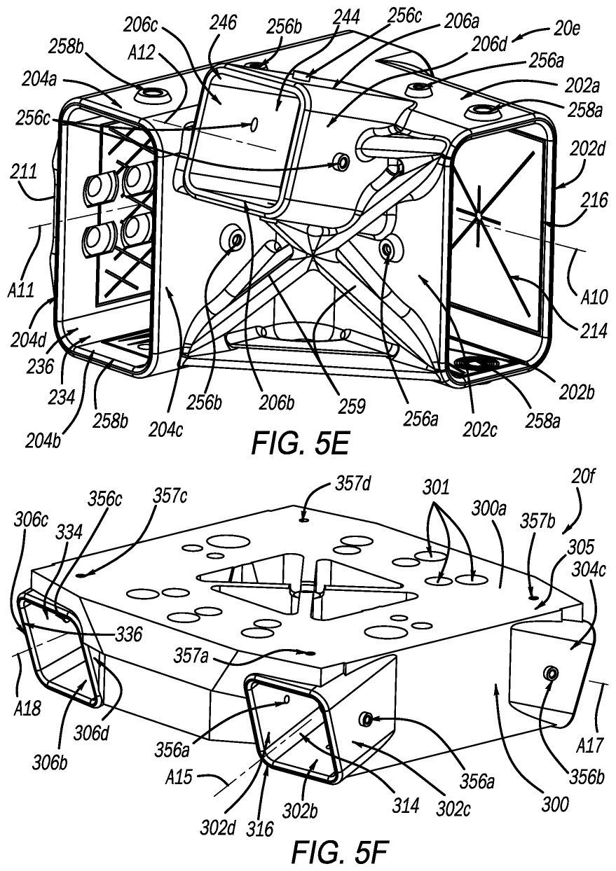

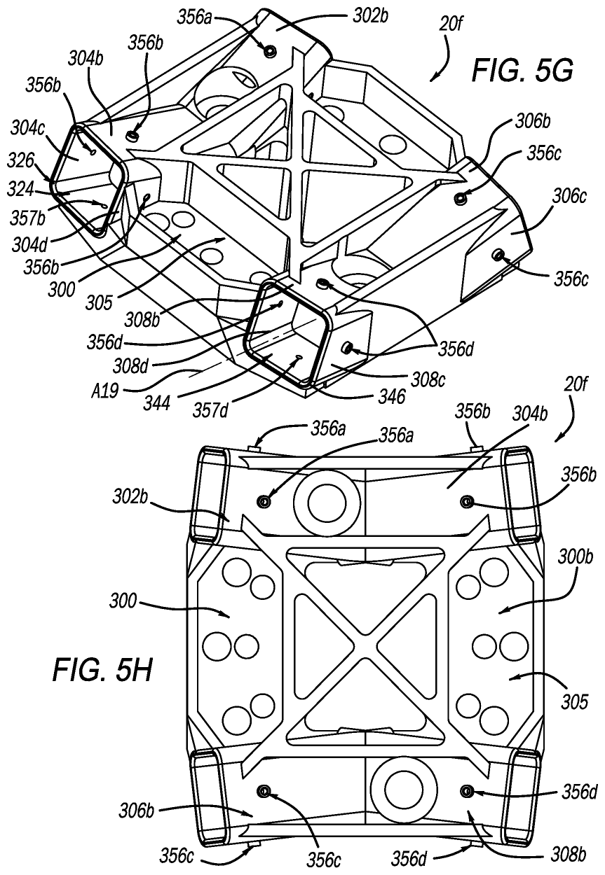

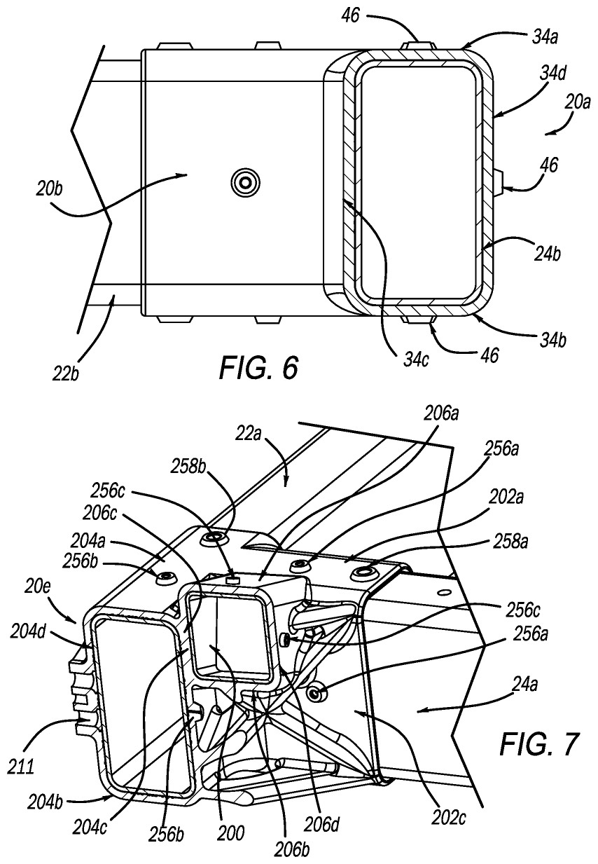

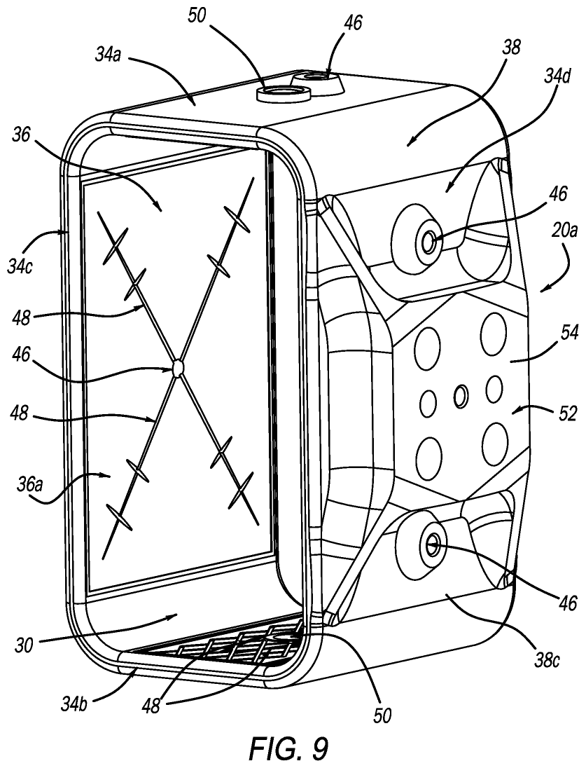

As shown in FIGS. 3 and 4, the nodes 20a are secured to various parts of the frame 18. That is, one or more nodes 20a may be secured to a respective frame member 22a, 22b and/or one or more nodes 20a may be attached to a respective cross member 24a, 24b, 24c. With reference to FIGS. 5A, 6, and 9, each node 20a includes a plurality of walls 34a 34b, 34c, 34d that cooperate with each other to define a closed profile having an annular shape. In the example illustrated, the annular shape is rectangular. In some forms, the node 20a includes one or more walls such that the annular shape is circular, pentagonal, hexagonal, or any other suitable shape. Each wall 34a, 34b, 34c, 34d has an interior side 36 and an exterior side 38. The closed profile is disposed about an axis A (FIG. 5A) such that the interior sides 36 of the walls 34a, 34b, 34c, 34d cooperate with each other to define a cavity 40 and at least one end aperture 42 open to the cavity 40 through respective axial end of the node 20a. In this way, the end apertures 42 may receive a portion of the frame 18.

Each node 20a further includes a plurality of ports 46, a plurality of locating features 50, and at least one mounting feature 52. A bonding agent (e.g., adhesive such as epoxy) may be injected into the ports 46 to bond the node 20a to the frame 18 as described in more detail below. In the example illustrated, each wall 34a, 34b, 34c, 34d includes at least one port 46 having an outlet open through the interior side 36 of the wall 34a, 34b, 34c, 34d and an inlet open through the exterior side 38 of the wall 34a, 34b, 34c, 34d. In some forms, one wall 34a, 34b, 34c, 34d or less than all walls 34a, 34b, 34c, 34d may include the port 46 formed therein. An interior surface 36a of the interior side 36 of each wall 34a, 34b, 34c, 34d defines a plurality of recessed channels 48 that intersect the outlet of the port 46. In one configuration, the recessed channels 48 in the interior side 36 of one wall 34a, 34b, 34c, 34d may form a pattern that may be different from a pattern formed in the recessed channels 48 in the interior side 36 of another wall 34a, 34b, 34c, 34d. The recessed channels 48 in the interior side 36 of each wall 34a, 34b, 34c, 34d may include arcuate channels, linear channels, inclined channels, or a combination of arcuate, linear, and/or inclined channels.

The locating features 50 may facilitate positioning and holding of the node 20a onto the frame 18 prior to bonding the node 20a onto the frame 18 using the bonding agent. The locating features 50 are apertures formed in the node 20a. Each locating feature 50 includes an outlet open through the interior side 36 of the respective wall 34a, 34b and an inlet open through the exterior side 38 of the respective wall 34a, 34b. In the example illustrated, one locating feature 50 is formed in the wall 34a and is vertically aligned with a corresponding aperture (not shown) formed in the frame 18, and one locating feature is formed in the wall 34b and is vertically aligned with another corresponding aperture (not shown) formed in the frame 18. In this way, a pin (not shown) may extend through each locating feature 50 and the corresponding aperture to temporarily hold the location of the node 20a on the frame 18 until the bonding agent bonds the node 20a to the frame 18. In some configurations, locating features 50 may be formed in the walls 34c, 34d, instead of, or in addition to, the locating features 50 formed in the walls 34a, 34b.

In the example illustrated, the locating feature 50 on the wall 34a is adjacent to a respective port 46 on the wall 34a and the locating feature 50 on the wall 34b is adjacent a respective port 46 on the wall 34b. It should be understood that the recessed channels 48 in the interior side 36 of the wall 34a, 34b may be spaced apart from the outlet of the locating feature 50 and/or extend around the outlet of the locating feature 50. In this way, the bonding agent injected into the port 46 is inhibited from flowing out of the locating feature 50 onto the exterior side 38 of the walls 34a, 34b. In some forms, the locating feature 50 on the wall 34a and the respective port 46 on the wall 34a may be located at opposite ends of the wall 34a, and locating feature 50 on the wall 34b and the respective port 46 on the wall 34b may be located at opposite ends of the wall 34b.

The mounting feature 52 is configured to secure a structure 60 (FIG. 2) onto the first node 20a. In the example illustrated, the structure 60 is configured to attach or otherwise secure the workpiece 12 to the robotic end effector 16. In one example, the structure 60 is mounted to the mounting feature 52 and includes one or more magnets (not specifically shown). The magnets may be energized such that the workpiece 12 is attached to the robotic end effector 16 and may be de-energized such that the workpiece 12 is detached from the robotic end effector 16. In some forms, the structure 60 may include hooks, gripping arms, or another suitable structure to grasp, hold or otherwise secure the workpiece 12 onto the robotic end effector 16 such that the workpiece 12 can be moved from one location to another, for example.

In the example illustrated, the mounting feature 52 is formed on the exterior side 38 of the wall 34d of the node 20a. In some forms, the mounting feature 52 may be formed on the exterior side 38 of another wall 34a, 34b, 34c, instead of, or in addition to, being formed on the exterior side 38 of the wall 34d. The mounting feature 52 may include a surface 54 that is raised from an exterior surface 38c or otherwise located a predetermined distance from the exterior surface 38c. The surface 54 includes a plurality of apertures 56 formed therein. In the example illustrated, an adapter 58 (FIG. 2) is mounted to the mounting feature 52 and the structure 60 is secured to the adapter 58. In some forms, the structure 60 may be secured directly to the mounting feature 52.

In some configurations, as shown in FIG. 3, the robotic end effector 16 may include nodes 51a disposed on the cross members 24a between two nodes 20e. Each node 51a may include two mounting features 52a. In some configurations, the robotic end effector 16 may also include nodes 51b disposed on a respective frame member 22a, 22b that do not include mounting features. In such configuration, a support structure 55 may extend in the transverse direction Y and may be attached to the nodes 51b such that the robotic end effector 16 may be positioned or disposed on a stand or rack (not shown) via the support structure 55.

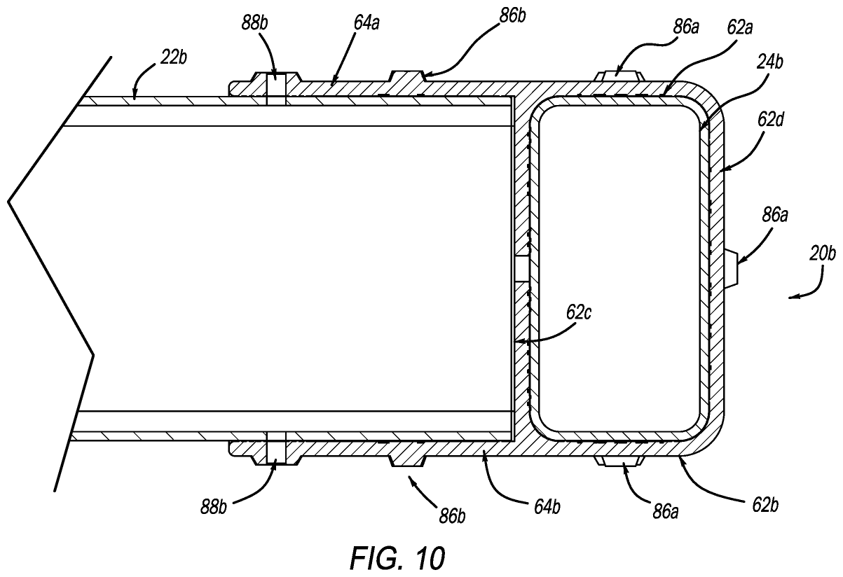

With reference to FIGS. 4, 5B, and 10, the nodes 20b attach a respective frame member 22a, 22b to the cross member 24b. Each node 20b includes a plurality of first walls 62a 62b, 62c, 62d and a plurality of second walls 64a, 64b, 64c, 64d. The plurality of first walls 62a, 62b, 62c, 62d cooperate with each other to define a closed profile having an annular shape. In the example illustrated, the annular shape is rectangular. In some forms, each node 20b includes one or more first walls such that the annular shape is circular, pentagonal, hexagonal, or any other suitable shape. Each first wall 62a, 62b, 62c, 62d has an interior side and an exterior side. The closed profile is disposed about an axis A1 such that the interior sides of the walls 62a, 62b, 62c, 62d cooperate with each other to define a cavity 70 and end apertures 72 (only one shown in FIG. 5B) open to the cavity 70 through an axial end of the node 20b. In this way, the end aperture 72 may receive the cross member 24b of the frame 18.

The plurality of second walls 64a, 64b, 64c, 64d cooperate with each other to define a closed profile having an annular shape. In the example illustrated, the closed profile formed by the second walls 64a, 64b, 64c, 64d extend in a direction perpendicular from the closed profile formed by the first walls 62a, 62b, 62c, 62d. In some forms, the closed profile formed by the second walls 64a, 64b, 64c, 64d may extend in an oblique direction from the closed profile formed by the first walls 62a, 62b, 62c, 62d. In some forms, each node 20b may include one or more second walls such that the annular shape is circular, pentagonal, hexagonal, or any other suitable shape. Each second wall 64a, 64b, 64c, 64d has an interior side and an exterior side. The closed profile is disposed about an axis A2 such that the interior sides of the second walls 64a, 64b, 64c, 62d cooperate with each other to define a cavity (not specifically shown) and at least one end aperture (not specifically shown) open to the cavity through a respective axial end of the node 20b. In this way, the end aperture may receive the respective frame member 22a, 22b of the frame 18.

Each node 20b further includes a plurality of first ports 86a, a plurality of second ports 86b, first recessed channels (not shown), second recessed channels (not shown), a plurality of first locating features 88a, and a plurality of second locating features 88b. A bonding agent (e.g., adhesive such as epoxy) may be injected into the first ports 86a to bond the node 20b to the cross member 24b and a bonding agent may be injected into the second ports 86b to bond to the node 20b to the frame members 22a, 22b. In the example illustrated, each first wall 62a, 62b, 62c, 62d includes at least one first port 86a and each second wall 64a, 64b, 64c, 64d includes at least one second port 86b. The structure and function of the first and second ports 86a, 86b may be similar or identical to the ports 46 described above, and therefore, will not be described again in detail.

The first recessed channels (not shown) are formed in an interior side (not shown) of each first wall 62a, 62b, 62c, 62d and intersect an outlet (not shown) of the first port 86a. Similarly, the second recessed channels (not shown) are formed in an interior side (not shown) of each second wall 64a, 64b, 64c, 64d and intersect an outlet (not shown) of the second port 86b. The structure and function of the first and second recessed channels may be similar or identical to that of the recessed channels 48 described above, and therefore, will not be described again in detail.

In the example illustrated, one first locating feature 88a is formed in the first wall 62a and is vertically aligned with a corresponding aperture (not shown) formed in the frame 18, and one first locating feature 88a is formed in the first wall 62b and is vertically aligned with another corresponding aperture (not shown) formed in the frame 18. Similarly, one second locating feature 88b is formed in the second wall 64a and is vertically aligned with a corresponding aperture (not shown) formed in the frame 18, and one second locating feature 88b is formed in the second wall 64b and is vertically aligned with another corresponding aperture (not shown) formed in the frame 18. The structure and functions of the first and second locating features 88a, 88b may be similar or identical to the locating features 50 described above, and therefore, will not be described again in detail. Connecting members 89 may connect one or more of the first walls 62a, 62b, 62c, 62d to one or more of the second walls 64a, 64b, 64c, 64d.

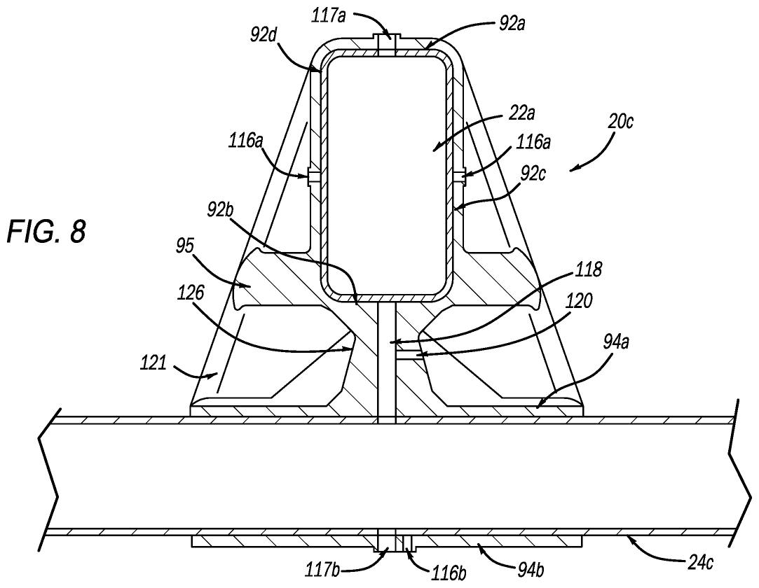

With reference to FIGS. 4, 50, and 8, the nodes 20c attach a respective frame member 22a, 22b to the cross member 24c. Each node 20c includes a plurality of first walls 92a 92b, 92c, 92d, a plurality of second walls 94a, 94b, 94c, 94d, and a connecting member 95. The plurality of first walls 92a, 92b, 92c, 92d cooperate with each other to define a closed profile having an annular shape. In the example illustrated, the annular shape is rectangular. In some forms, each node 20c includes one or more first walls such that the annular shape is circular, pentagonal, hexagonal, or any other suitable shape. Each first wall 92a, 92b, 92c, 92d has an interior side and an exterior side. The closed profile is disposed about an axis A3 such that the interior sides of the first walls 92a, 92b, 92c, 92d cooperate with each other to define a cavity 100 and end apertures 102 open to the cavity 100 through axial ends of the closed profile. In this way, the end apertures 102 may receive the respective frame member 22a, 22b of the frame 18.

The plurality of second walls 94a, 94b, 94c, 94d cooperate with each other to define a closed profile having an annular shape. In the example illustrated, the closed profile formed by the second walls 94a, 94b, 94c, 94d extend in a direction perpendicular from the closed profile formed by the first walls 92a, 92b, 92c, 92d. In some forms, each node 20c includes one or more second walls such that the annular shape is circular, pentagonal, hexagonal, or any other suitable shape. Each second wall 94a, 94b, 94c, 94d has an interior side and an exterior side. The closed profile is disposed about an axis A4 such that the interior sides 106 of the second walls 94a, 94b, 94c, 92d cooperate with each other to define a cavity 110 and end apertures 112 open to the cavity 110 through respective axial ends of the node 20c. In this way, the end apertures 112 may receive the cross member 24c of the frame 18. The connecting member 95 extends in a vertical direction and connects the first wall 94a and the second wall 92b to each other.

Each node 20c further includes a plurality of first ports 116a, a plurality of second ports 116b, first recessed channels (not shown), second recessed channels (not shown), at least one first locating feature 117a, at least one second locating feature 117b, an internal port 118 and a third port 120. A bonding agent (e.g., adhesive such as epoxy) may be injected into the first ports 116a to bond the node 20c to the fame members 22a, 22b. A bonding agent may be injected into the second ports 116b to bond the node 20c to the cross member 24c. A bonding agent may be injected into the third port 120 and flow through the internal port 118 to further bond the node 20c to the frame 18 (i.e., bond the node 20c to both the cross member 24c and the respective frame member 22a, 22b). In the example illustrated, each first wall 92a, 92c, 92d includes at least one first port 116a and each second wall 94b, 94c, 94d includes at least one second port 116b. The structure and function of the first and second ports 116a, 116b may be similar or identical to the ports 46 described above, and therefore, will not be described again in detail.

The first recessed channels are formed in an interior side of each first wall 92a, 92b, 92c, 92d and intersect an outlet of the first port 116a. Similarly, the second recessed channels (not shown) are formed in an interior side (not shown) of each second wall 94a, 94b, 94c, 94d and intersect an outlet (not shown) of the second port 116b. The structure and function of the first and second recessed channels may be similar or identical to that of the recessed channels 48 described above, and therefore, will not be described again in detail.

In the example illustrated, one first locating feature 117a is formed in the first wall 92a and is vertically aligned with a corresponding aperture (not shown) formed in the frame 18, and one first locating feature 117b is formed in the second wall 94b and is vertically aligned with another corresponding aperture (not shown) formed in the frame 18. The structure and functions of the first and second locating features 117a, 117b may be similar or identical to the locating features 50 described above, and therefore, will not be described again in detail.

The internal port 118 extends from the first wall 92b through the connecting member 95, to the second wall 94a. The third port 120 is located within the connecting member 95 and extends in a direction perpendicular to the internal port 118. The third port 120 includes an outlet that opens through to the internal port 118 and an inlet that opens through to an exterior side 121 of the connecting member 95. In this way, a bonding agent may be injected into the third port 120 to bond the node 20c to both the cross member 24c and the respective frame member 22a, 22b. The internal port 118 includes a size (e.g., a diameter) that is greater than a size (e.g., a diameter) of the third port 120. Connecting members 126 may connect one or more of the first walls 92a, 92b, 92c, 92d to one or more of the second walls 94a, 94b, 94c, 94d.

With reference to FIGS. 4 and 5D, each node 20d includes a plurality of walls 134a 134b, 134c, 134d that cooperate with each other to define a closed profile having an annular shape. In the example illustrated, the annular shape is square. In some forms, the node 20d includes one or more walls such that the annular shape is circular, pentagonal, hexagonal, or any other suitable shape. Each wall 134a, 134b, 134c, 134d has an interior side and an exterior side. The closed profile is disposed about an axis A6 such that the interior sides of the walls 134a, 134b, 134c, 134d cooperate with each other to define a cavity 140 and end apertures 142 open to the cavity 140 through respective axial ends of the node 20d. In this way, the end apertures 142 may receive the cross member 24c.

Each node 20d further includes a plurality of ports 146, recessed channels, a plurality of locating features 150, and at least one mounting structure 152. A bonding agent (e.g., adhesive such as epoxy) may be injected into the ports 146 to bond the node 20d to the frame 18. In the example illustrated, each wall 134a, 134b, 134c, 134d includes at least one port 146. The structure and function of the ports 146 may be similar or identical to the ports 46 described above, and therefore, will not be described again in detail.

The recessed channels are formed in an interior side of each wall 134a, 134b, 134c, 134d and intersect an outlet (not shown) of the port 146. The structure and function of the recessed channels may be similar or identical to that of the recessed channels 48 described above, and therefore, will not be described again in detail.

In the example illustrated, one first locating feature 150 is formed in the wall 134a and is vertically aligned with a corresponding aperture (not shown) formed in the frame 18, and one locating feature 150 is formed in the wall 134b and is vertically aligned with another corresponding aperture (not shown) formed in the frame 18. The structure and function of the locating features 150 may be similar or identical to the locating features 50 described above, and therefore, will not be described again in detail.

Each mounting structure 152 extends from one wall 134a, 134b, 134c, 134d of the node 20d to a location where the workpiece 14 is mounted to an end face 156 of the mounting structure 152. In the example illustrated, the mounting structure 152 includes a lattice array 157 having a plurality of beams or struts 158 oriented in a predetermined configuration. In the example illustrated, the beams 158 are solid and have a cylindrical shape. In some forms, the beams 158 are hollow and have a different shape (e.g., rectangular or square shape). In the example illustrated, the end face 156 is planar and is configured to be secured to a portion (e.g., a rail or cross member) of the workpiece 12. In some forms, the end face 156 may be arcuate or any other suitable shape that is able to secure a portion of the workpiece 12 thereto.

With reference to FIGS. 4, 5E, and 7, the nodes 20e attach a respective frame member 22a, 22b to the node 20f via a respective rail 200 (FIG. 7), and attach the frame members 22a, 22b to each other via a respective cross member 24a (FIG. 4). Each node 20e includes a plurality of first walls 202a 202b, 202c, 202d, a plurality of second walls 204a, 204b, 204c, 204d, and a plurality of third walls, 206a, 206b, 206c, 206d. The plurality of first walls 202a, 202b, 202c, 202d cooperate with each other to define a closed profile having an annular shape. In the example illustrated, the annular shape is rectangular. In some forms, each node 20e includes one or more first walls such that the annular shape is circular, pentagonal, hexagonal, or any other suitable shape. Each first wall 202a, 202b, 202c, 202d has an interior side and an exterior side. The closed profile is disposed about an axis A10 such that the interior sides of the walls 202a, 202b, 202c, 202d cooperate with each other to define a cavity 214 and an end aperture 216 open to the cavity 214 through an axial end of the node 20e. In this way, the end aperture 216 may receive the cross member 24a of the frame 18.

The plurality of second walls 204a, 204b, 204c, 204d cooperate with each other to define a closed profile having an annular shape. In the example illustrated, the closed profile formed by the second walls 204a, 204b, 204c, 204d extend in a direction perpendicular from the closed profile formed by the first walls 202a, 202b, 202c, 202d. In some forms, each node 20e may include one or more second walls such that the annular shape is circular, pentagonal, hexagonal, or any other suitable shape. Each second wall 204a, 204b, 204c, 204d has an interior side and an exterior side. The closed profile is disposed about an axis A11 such that the interior sides of the second walls 204a, 204b, 204c, 204d cooperate with each other to define a cavity 234 and end apertures 236 open to the cavity 234 through respective axial ends of the node 20e. In this way, the end apertures 236 may receive the respective frame member 22a, 22b of the frame 18.

The plurality of third walls 206a, 206b, 206c, 206d cooperate with each other to define a closed profile having an annular shape. In the example illustrated, the closed profile formed by the third walls 206a, 206b, 264c, 206d extends outward at an angle from the closed profile formed by the first walls 202a, 202b, 202c, 202d and at an angle from the closed profile formed by the second walls 204a, 204b, 204c, 204d. In some forms, each node 20e may include one or more third walls such that the annular shape is circular, pentagonal, hexagonal, or any other suitable shape. Each third wall 206a, 206b, 206c, 206d has an interior side and an exterior side. The closed profile is disposed about an axis A12 such that the interior sides of the third walls 206a, 206b, 206c, 206d cooperate with each other to define a cavity 244 and an end aperture 246 open to the cavity 244 through an axial end of the node 20e. In this way, the end aperture 246 may receive the respective rail 200. The axis A12 extends at an angle relative to the axis A11. In the example illustrated, the angle is an acute angle.

Each node 20e further includes a plurality of first ports 256a, a plurality of second ports 256b, a plurality of third ports 256c, first recessed channel, second recessed channels, first locating features 258a and second locating features 258b. A bonding agent (e.g., adhesive such as epoxy) may be injected into the first ports 256a to bond the node 20e to the cross members 24a, a bonding agent may be injected into the second ports 256b to bond the node 20e to the frame members 22a, 22b, and a bonding agent may be injected into the third ports 256c to bond the node 20e to the rail 200. In the example illustrated, each first wall 202a, 202b, 202c, 202d includes at least one first port 256a, each second wall 204a, 204b, 204c, 204d includes at least one second port 256b, and each third wall 206a, 206b, 206c, 206d includes at least one third port 256c. The structure and function of the first, second, and third ports 256a, 256b, 256c may be similar or identical to the ports 46 described above, and therefore, will not be described again in detail.

The first recessed channels are formed in an interior side of each first wall 202a, 202b, 202c, 202d and intersect an outlet of the first port 256a. The second recessed channels are formed in an interior side of each second wall 204a, 204b, 204c, 204d and intersect an outlet (not shown) of the second port 256b. The structure and function of the first and second recessed channels may be similar or identical to that of the recessed channels 48 described above, and therefore, will not be described again in detail.

In the example illustrated, one first locating feature 258a is formed in the first wall 202a and is vertically aligned with a corresponding aperture (not shown) formed in the frame 18, and one first locating feature 258a is formed in the first wall 202b and is vertically aligned with another corresponding aperture (not shown) formed in the frame 18. Similarly, one second locating feature 258b is formed in the second wall 204a and is vertically aligned with a corresponding aperture (not shown) formed in the frame 18, and one second locating feature 258b is formed in the second wall 204b and is vertically aligned with another corresponding aperture (not shown) formed in the frame 18. The structure and function of the first and second locating features 258a, 258b may be similar or identical to the locating features 50 described above, and therefore, will not be described again in detail. Connecting members 259 may connect one or more of the first walls 202a, 202b, 202c, 202d to one or more of the second walls 204a, 204b, 204c, 6204d and/or of the third walls 206a, 206b, 206c, 206d. In the example illustrated, mounting features 211 are formed in the second wall 204d of the nodes 204. The mounting features 211 may be similar or identical to the mounting features 52 described above, and therefore, will not be described again in detail.

With reference to FIGS. 4, 5F, and 5G, the node 20f is disposed between the frame members 22a, 22b and attaches the robot arm 14 to the nodes 20e via a respective rail 200. The node 20f includes a hub 300, a plurality of first walls 302b, 302c, 302d, a plurality of second walls 304b, 304c, 304d, a plurality of third walls 306b, 306c, 306d, and a plurality of fourth walls 308b, 308c, 308d. The hub 300 includes a wall 305 having a planar, upper surface 300a and a lower surface 300b. The upper surface 300a is raised from the frame 18 such that a predetermined distance is between the upper surface 300a and the frame 18. The planar surface 300a includes a plurality of apertures 301 formed therethrough so that a second end 14b of the robot arm 14 is secured to the node 20f. The second end 14b of the robot arm 14 is secured to the planar surface 300a via an adapter (not shown). In some forms, the second end 14b of the robot arm 14 is secured directly to the planar surface 300a of the node 20f without an adapter.

With reference to FIGS. 5F and 5G, the plurality of first walls 302b, 302c, 302d extend from a respective end of the hub 300 and cooperate with each other to define a closed profile having an annular shape. In the example illustrated, the annular shape is square. In some forms, the node 20f includes one or more first walls such that the annular shape is circular, pentagonal, hexagonal, or any other suitable shape. Each first wall 302b, 302c, 302d has an interior side and an exterior side. The closed profile is disposed about an axis A15 such that the interior sides of the walls 302b, 302c, 302d cooperate with each other to define a cavity 314 and an end aperture 316 open to the cavity 314. In this way, the end aperture 316 may receive a respective rail 200. The axis A15 extends at an angle relative to a plane extending along the planar surface 300. In the example illustrated, the angle is an acute angle.

The plurality of second walls 304b, 304c, 304d extend from a respective end of the hub 300 and cooperate with each other to define a closed profile having an annular shape. In the example illustrated, the annular shape is square. In some forms, the node 20f includes one or more second walls such that the annular shape is circular, pentagonal, hexagonal, or any other suitable shape. Each second wall 304b, 304c, 304d has an interior side and an exterior side. The closed profile is disposed about an axis A17 such that the interior sides of the walls 304b, 304c, 304d cooperate with each other to define a cavity 324 and an end aperture 326 open to the cavity 324. In this way, the end aperture 326 may receive a respective rail 200. The axis A17 extends at an angle relative to the plane extending along the planar surface 300. In the example illustrated, the angle is an acute angle.

The plurality of third walls 306b, 306c, 306d extend from the hub 300 and cooperate with each other to define a closed profile having an annular shape. In the example illustrated, the annular shape is square. In some forms, the node 20f includes one or more third walls such that the annular shape is circular, pentagonal, hexagonal, or any other suitable shape. Each third wall 306b, 306c, 306d has an interior side and an exterior side. The closed profile is disposed about an axis A18 such that the interior sides of the walls 306b, 306c, 306d cooperate with each other to define a cavity 334 and an end aperture 336 open to the cavity 334. In this way, the end aperture 336 may receive a respective rail 200. The axis A18 extends at an angle relative to the plane extending along the planar surface 300. In the example illustrated, the angle is an acute angle.

The plurality of fourth walls 308b, 308c, 308d extend from a respective end of the hub 300 and cooperate with each other to define a closed profile having an annular shape. In the example illustrated, the annular shape is square. In some forms, the node 20f includes one or more fourth walls such that the annular shape is circular, pentagonal, hexagonal, or any other suitable shape. Each fourth wall 308b, 308c, 308d has an interior side and an exterior side. The closed profile is disposed about an axis A19 such that the interior sides of the walls 308b, 3080, 308d cooperate with each other to define a cavity 344 and an end aperture 346 open to the cavity 344. In this way, the end aperture 346 may receive a respective rail 200. The axis A19 extends at an angle relative to the plane extending along the planar surface 300. In the example illustrated, the angle is an acute angle.

The node 20f further includes a plurality of first ports 356a, a plurality of second ports 356b, a plurality of third ports 356c, and a plurality of fourth ports 356d. A bonding agent (e.g., adhesive such as epoxy) may be injected into the first ports 356a to bond the node 20f to the respective rail 200, a bonding agent may be injected into the second ports 356b to bond the node 20f to the respective rail 200, a bonding agent may be injected into the third ports 356c to bond the node 20f to the respective rail 200, and a bonding agent may be injected into the fourth ports 356d to bond the node 20f to the respective rail 200. In the example illustrated, each first wall 302b, 302c, 302d includes at least one first port 356a, each second wall 304b, 304c, 304d includes at least one second port 356b, each third wall 306b, 306c, 306d includes at least one third port 356c, and each fourth wall 308b, 308c, 308d includes at least one fourth port 356d. The structure and function of the first, second, third, and fourth ports 356a, 356b, 356c, 356d may be similar or identical to the ports 46 described above, and therefore, will not be described again in detail.

One first port 357a includes an inlet that opens through to the upper surface 300a and an outlet that opens through to the cavity 314. One second port 357b includes an inlet that opens through to the upper surface 300a and an outlet that opens through to the cavity 324. One third port 357c includes an inlet that opens through to the upper surface 300a and an outlet that opens through to the cavity 334. One fourth port 357d includes an inlet that opens through to the planar surface 300 and an outlet that opens through to the cavity 344.

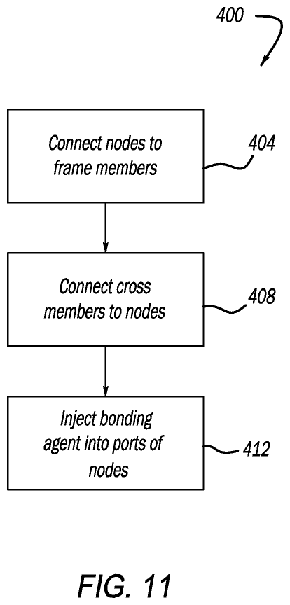

With reference to FIG. 11, a method for assembling the robotic end effector 16 will be described in detail. First, at 404, the nodes 20a, 20b, 20c, 20e, 51b are connected to a respective frame member 22a, 22b. That is, in the example illustrated, the nodes 20a, 20b, 20c, 20e, 51b are slid onto the respective frame members 22a, 22b in the following order: the nodes 20e are slid onto the frame members 22a, 22b, then two of the nodes 20a are slid onto respective ends 23b of the frame members 22a, 22b, then the nodes 51b are slid onto the frame members 22a, 22b, then two more of the nodes 20a are slid onto the frame members 22a, 22b, then the nodes 20c are slid onto the frame members 22a, 22b, then the nodes 20b are slid onto the frame members 22a, 22b. It should be understood that the nodes 20a, 20b, 20c, 20e, 51b may take a different form or pattern than what's shown in the figures. That is, nodes 20c may be located closer to the nodes 20e than nodes 51b, for example. In another form, two of the nodes 20a may be removed from the frame members 22a, 22b.

Then, at 408, the cross members 24a, 24b, 24c are connected to respective nodes 20b, 20c, 20e. That is, the cross members 24a are connected to the nodes 20e, the cross member 24b is connected to the nodes 20b and the cross member 24c is connected to the nodes 20c. Then, the nodes 20d are slid onto the cross member 24c and two more of the nodes 20a are slid onto the cross member 24b.

Then, at 412, the nodes 20a, 20b, 20c, 20d, 20e, 51a, 51b are held in place by respective pins while a bonding agent is injected into ports of the nodes 20a, 20b, 20c, 20d, 20e, 20f, 51a, 51b to bond the nodes 20a, 20b, 20c, 20d, 20e, 20f, 51a, 51b to the frame 18. The robotic end effector 16 of the present disclosure provides the benefit of securing the frame 18 together using various nodes and a bonding agent.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A robotic end effector comprising:
a first node including at least one wall, the at least one wall having a corresponding interior side and a corresponding exterior side,
wherein the at least one wall defines a closed profile disposed about an axis such that the corresponding interior side of the at least one wall defines a cavity and the at least one wall defines an end aperture open to the cavity through an axial end of the first node, the end aperture being configured to receive a first frame member,
wherein the at least one wall includes a first port having a first outlet open through the corresponding interior side of the at least one wall and a first inlet open through the corresponding exterior side of the at least one wall,
wherein corresponding the interior side of the at least one wall defines a plurality of first recessed channels that intersect the first outlet of the first port.

2. The robotic end effector of claim 1, wherein the first node is made of plastic.

3. The robotic end effector of claim 1, wherein the corresponding interior side of the first node defines an interior surface, and wherein the first recessed channels are formed in the interior surface.

4. The robotic end effector of claim 1, wherein the first node includes a locating feature that is adjacent the first port and configured to facilitate positioning of the first node relative to the first frame member, and wherein the locating feature includes a second outlet open through the corresponding interior side of the first node and a second inlet end open through to the corresponding exterior side of the first node.

5. The robotic end effector of claim 4, wherein the first recessed channels are spaced apart from the second outlet of the locating feature and extend around the second outlet of the locating feature.

6. The robotic end effector of claim 1, wherein the first node further includes:
a second port that includes a second outlet open through the corresponding interior side of the first node and a second inlet open through the corresponding exterior side of the first node; and
second recessed channels formed in the corresponding interior side of the first node and intersecting the second outlet of the second port.

7. The robotic end effector of claim 6, wherein the second recessed channels have a pattern that is different from a pattern of the first recessed channels.

8. The robotic end effector of claim 1, wherein the first node includes a mounting feature that is adjacent to the first port and configured to mount a structure to the first node.

9. The robotic end effector of claim 8, wherein the mounting feature comprises a plurality of threaded apertures.

10. The robotic end effector of claim 1, further comprising the first frame member, wherein a bonding agent flows through the first port to the first recessed channels to attach the first node to the first frame member.

11. The robotic end effector of claim 10, further comprising a second node that is spaced apart from the first node and attached to the first frame member.

12. A robotic end effector comprising:
a frame including a first member and a second member that extends in a direction that is different than the first member; and
a first node including a first interior side, a second interior side, and an exterior side, the first interior side faces the first member and defines a first interior cavity that receives the first member, the second interior side faces the second member and defines a second interior cavity that receives the second member, the exterior side faces away from the frame, the first node further includes:
a first port and first recessed channels, the first port includes a first outlet that opens through to the first interior side of the first node and a first inlet that opens through to the exterior side of the first node, the first recessed channels formed in the first interior side of the first node proximate the first member and intersecting the first outlet of the first port; and
a second port and second recessed channels, the second port includes a second outlet that opens through to the second interior side of the first node and a second inlet that opens through to the exterior side of the first node, the second recessed channels are formed in the second interior side of the first node proximate the second member and intersecting the second outlet of the second port.

13. The robotic end effector of claim 12, wherein the second recessed channels form a pattern that is different from a pattern of the first recessed channels.

14. The robotic end effector of claim 12, further comprising a second node spaced apart from the first node and attached to the frame.

15. The robotic end effector of claim 12, wherein the first node includes a mounting feature that is adjacent to the first port and configured to mount a structure to the first node.

16. The robotic end effector of claim 12, wherein the first node further includes:
a third port that includes a third outlet and a third inlet, the third inlet opens through to the exterior side of the first node; and
an internal port located within the first node and extending from the first interior side of the first node to the second interior side of the first node, the internal port in fluid communication with the third outlet of the third port.

17. The robotic end effector of claim 16, wherein the internal port includes a diameter that is greater than a diameter of the third port.

18. The robotic end effector of claim 12, wherein the first node includes a locating feature that is adjacent to one of the first and second ports and that facilitates positioning of the first node relative to the frame, and wherein the locating feature includes a third outlet that opens through to one of the first and second interior sides of the first node and a third inlet that opens through to the exterior side of the first node.

19. The robotic end effector of claim 18, wherein one of the first and second recessed channels are spaced apart from the third outlet of the locating feature and extend around the third outlet of the locating feature.

20. A method of assembling a robotic end effector, the method comprising:
inserting a first frame member into a first interior cavity of a node such that first recessed channels defined by a first interior surface of the first interior cavity are proximate the first frame member;
inserting a second frame member into a second interior cavity of the node such that second recessed channels defined by a second interior surface of the second interior cavity are proximate the second frame member;
injecting a first bonding agent into a first port of the node such that it flows along the first recessed channels in the first interior surface; and
injecting a second bonding agent into a second port of the node such that it flows along the second recessed channels in the second interior surface.
